(19) United States
(12) Patent Application Publication
(10) Pub. No.: US 2020/0023673 A1
(43) Pub. Date: Jan. 23, 2020

(54) PAINT BRUSH CLEANING NOZZLE

(71) Applicant: James Lujan, Federal Way, WA (US)

(72) Inventor: James Lujan, Federal Way, WA (US)

(21) Appl. No.: 16/039,052

(22) Filed: Jul. 18, 2018

(51) Int. Cl. B44D 3/00; A46B 17/06

(52) U.S. Cl. CPC B44D 3/006; B08B 3/02; A46B 17/06

(57) ABSTRACT

A paint brush cleaning nozzle that includes: a hose coupling whereas the house coupling is adapted for connection to a hose; waterflow tubing extending from the hose coupling; a plurality of teeth extending from the waterflow coupling; and a hole in each tooth of the plurality of teeth allowing for the flow of fluid through the nozzle. The paint brush cleaning nozzle may also include a control valve where the control valve controls the flow of fluid through the plurality of teeth and an o-ring within the coupling.

### CROSS REFERENCE TO OTHER APPLICATIONS

This application claims priority to U.S. Provisional Application Ser. No. 62/533,802 filed on Jul. 25, 2017.

### BACKGROUND OF THE INVENTION

### Field of Invention

The present invention relates to a nozzle used for cleaning paint brushes.

### Description of Related Art

Painting is a craft that involves use of paint brushes and rollers for application of paint over a surface such as a wall or ceiling. Painters frequently use multiple paint brushes on a single job and one task associated with painting involves the cleaning of the brush after use. Normally a user runs water over the brush and uses another cleaning utensil to scrub the brush or bristles in order to fully remove the paint. This cleaning method also applies for rollers that are used for painting, where water in combination with a cleaning brush or utensil is used to remove excess residue paint from the paint brush or roller. It would be therefore advantageous to have a specially designed nozzle that includes teeth, which allow the emission of water to assist in the cleaning of a paint applicator such as a brush or roller.

### SUMMARY OF THE INVENTION

The present invention relates to a paint brush cleaning nozzle that includes: a hose coupling whereas the house coupling is adapted for connection to a hose; waterflow tubing extending from the hose coupling; a plurality of teeth extending from the waterflow coupling; and a hole in each tooth of the plurality of teeth allowing for the flow of fluid through the nozzle. The paint brush cleaning nozzle may also include a control valve where the control valve controls the flow of fluid through the plurality of teeth and an o-ring within the coupling.

### BRIEF DESCRIPTION OF DRAWINGS

FIG. 1 depicts a side view of a paint cleaning nozzle in accordance with the present invention.

FIG. 2 depicts a top view and end view of the cleaning nozzle.

### DETAILED DESCRIPTION

The present invention relates to a paint brush cleaning nozzle that includes a plurality of teeth extending from water flow tubing that essentially makes up the body of the nozzle. The nozzle connects to the hose through a hose coupling and has a flow valve that allows for the opening and closing of water flow through the nozzle. Once attached to a hose, water flows through the nozzle into the teeth and is then released through holes provided in the plurality of teeth provided. Each tooth of the plurality of teeth includes an opening that allows flow of water therethrough.

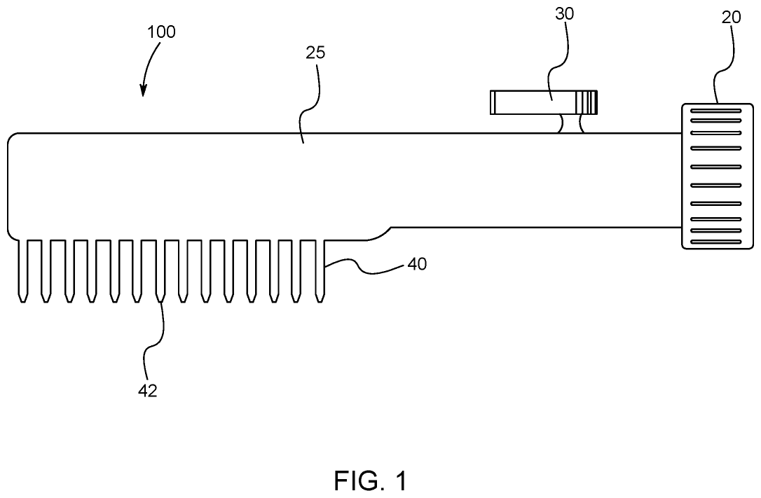

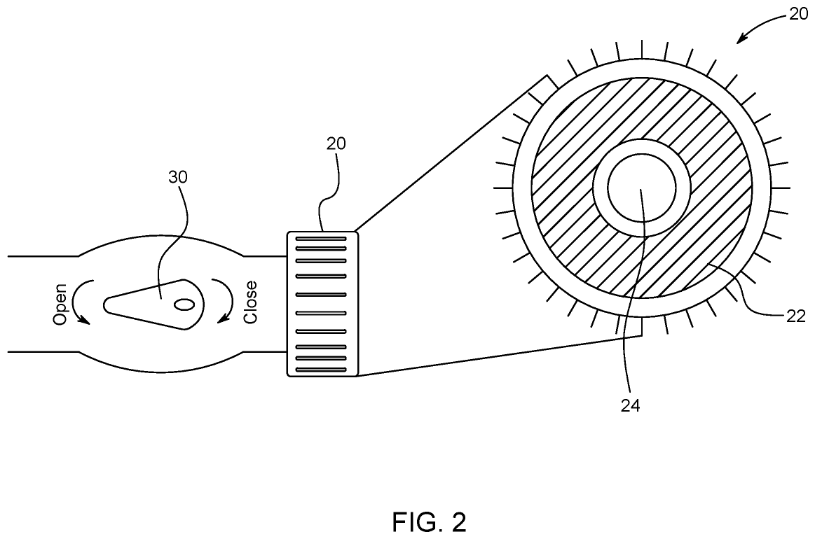

In reference to FIG. 1, a side view of a Paint Cleaning Nozzle 100 is depicted. The paint cleaning nozzle 100 includes a hose coupling 20 at one end of a water flow tubing 25. At the opposing end, a plurality of teeth 40 are shown extending from the water flow tubing 25. Each tooth includes an opening 42 that allows for the transmission of water or fluid through the teeth. A user connects the nozzle 100 to a hose with the hose coupling 20 and then allows for the flow of water therethrough. The teeth 40 may be applied to the paint brush or roller to allow for emission of the water through the teeth while the teeth are applied for abrasive application on a brush or roller. Water flows controlled through a control valve 30 shown in FIGS. 1 and 2.

FIG. 2 depicts a top view of the valve 30, which includes an ability to open and close water flow through the nozzle. The hose coupling 20 is also shown with an end view, where an opening 24 allows for a flow of water and a rubber o-ring 22 is provided to assist in coupling the hose coupler onto a hose outlet.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A paint brush cleaning nozzle comprising:
a hose coupling whereas the house coupling is adapted for connection to a hose;
waterflow tubing extending from the hose coupling;
a plurality of teeth extending from the waterflow coupling; and
a hole in each tooth of the plurality of teeth allowing for the flow of fluid through the nozzle.

2. The paint brush cleaning nozzle according to claim 1, further including a control valve where the control valve controls the flow of fluid through the plurality of teeth.

3. The paint brush cleaning nozzle according to claim 1, where the coupling includes an o-ring.
